(19) United States
(12) Patent Application Publication
(10) Pub. No.: US 2025/0349112 A1
(43) Pub. Date: Nov. 13, 2025

(54) Methods for Generating Image Data

(71) Applicants: ROBERT BOSCH GmbH, Stuttgart (DE); CARIAD SE, Wolfsburg (DE)

(72) Inventors: Paul Frydlewicz, Ludwigsburg (DE); Christian Connette, Leonberg (DE); Marcel Straub, Eislingen/Fils (DE)

(21) Appl. No.: 19/201,876

(22) Filed: May 7, 2025

(30) Foreign Application Priority Data
May 8, 2024 (DE) 10 2024 112 999.9

(51) Int. Cl. G06V 10/774; G06K 19/06; G06T 11/60; G06V 10/764; G06V 10/82; G06V 20/56; G06V 20/70

(52) U.S. Cl. CPC G06V 10/7747; G06K 19/06037; G06T 11/60; G06V 10/764; G06V 20/56; G06V 20/70; G06V 10/82

(57) ABSTRACT

The invention relates to a method for generating image data that are enhanced with at least one piece of binary and/or text information. The invention further relates to a data structure, a computer program, a device, and a memory medium.

### RELATED APPLICATION(S)

This application claims the benefit of German Application DE, 10 2024 112 999.9 (filed on May 8, 2024), the entirety of which is incorporated by reference herein.

### FIELD OF THE INVENTION

The invention relates to a method for generating image data. The invention further relates to a computer program, a data structure, a device, and a memory medium for this purpose.

### BACKROUND

In order to train machine learning models such as deep neural networks (DNNs) for image processing, it is often necessary to provide pieces of information concerning which objects can be found in an image, and which cannot. These pieces of information are also referred to as “labels.” These labels are typically stored in separate “label files” in various formats (for example, OpenLABEL (OLF) format).

One example of a widely used file format for storing labels is JSON. The OpenLABEL format (OLF), which uses Javascript Serializable Object Notation (JSON), is an example of a common data format.

Approaches in which container files are used are also known in the prior art. Container files can merge individual files, for example .zip archive or .tar archive files. The disadvantage is that each tool must implement the same naming convention in these container files. In addition, it is likely that individual files of the container will be passed on in the processing chain without their associated files.

Some image converters supply additional data which are encoded in additional lines or columns of the image. This information may contain the temperature or other relevant image data that are represented as bit values. However, these data are not visually encoded and therefore are not part of the visual image. If the embedded lines were compressed (using JPEG compression, for example), this information would probably be lost.

Techniques for embedding information in image data and concealing its presence are also described by the steganography process.

### SUMMARY

The subject matter of the invention involves a method having the features of claim 1, a data structure having the features of claim 9, a computer program having the features of claim 10, a device having the features of claim 11, and a computer-readable memory medium having the features of claim 12. Further features and details of the invention result from the respective subclaims, the description, and the drawings. Features and details that are described in conjunction with the method according to the invention naturally also apply in conjunction with the data structure according to the invention, the computer program according to the invention, the device according to the invention, and the computer-readable memory according to the invention, and vice versa in each case, so that with regard to the disclosure of the invention, reciprocal reference is always possible.

The subject matter of the invention relates in particular to a method for generating image data which preferably are or become enhanced with at least one piece of binary and/or text information.

The method according to the invention may comprise the following steps, which may preferably be carried out in succession or in any given order and/or repeatedly and/or automatedly:
providing a container image having at least one piece of image information, wherein the container image may provide an at least two-dimensional visual representation in which the at least one piece of image information is depicted, wherein the image information is preferably specific for sensor-based detection of the surroundings,
providing additional data, wherein the additional data may provide the at least one piece of binary and/or text information, wherein the at least one piece of binary and/or text information preferably includes at least one additional piece of information concerning the at least one piece of image information and/or the sensor-based detection and/or the (detected) surroundings,
encoding the additional data in order to preferably represent the additional data by at least one at least one-dimensional code,
embedding the encoded additional data in the container image in order to preferably depict the at least one at least one-dimensional code together with the at least one piece of image information in the visual representation.

This has the advantage that associated pieces of information, i.e., the at least one piece of image information and the at least one piece of binary and/or text information, may be reliably provided and further processed. Loss of data is prevented by integrating the pieces of information into a shared container image. The visual representation of the code has the further advantage that even lossy compression of the container image often cannot impair the usability of the code.

The embedding of the encoded additional data in the container image may take place using an image processing algorithm, for example. One option is to provide a shared visual representation region (i.e., the at least two-dimensional visual representation) and to add the code and the image information there. The (at least one) code and the (at least one) piece of image information may correspondingly be represented together; i.e., for a display of the container image may be similarly visible to the human eye. The code may also be integrated, for example, in a certain color or in a shape of the container image provided for this purpose. A further option is to discretely integrate the code by placing the (at least one) code in in a respective image area that is intended for same and that is less noticeable during examination of the container image. This may be the edge region of the container image, for example. In addition, color channels of the image which are less visible to the human eye, but still reliably machine-readable if necessary, may be used for this purpose for representing the code.

The at least one piece of image information may also be provided in the form of multiple pieces of image information. For example, at least two or at least three pieces of image information are depicted as separate images in the visual representation, preferably next to one another and/or spaced apart from one another and/or free of overlap. This has the advantage that associated images, for example images of a stereo camera or images recorded at essentially the same points in time, for example from various cameras that detect the same surroundings, may be jointly stored in a container image.

Furthermore, the at least one at least one-dimensional code, also in the form of at least two or at least three at least one-dimensional codes, may optionally be embedded in a container image. Here as well, the codes may be depicted by separate images in the visual representation, preferably next to one another and/or spaced apart from one another and/or free of overlap. In addition, the one or multiple codes may also be depicted in the visual representation free of overlap with the at least one piece of image information. The particular code may also be designed as a one- or two-dimensional code, and correspondingly as a two-dimensional code may optionally make use of a larger display area in the visual representation than the one-dimensional code. Also conceivable is a combination of one- and two-dimensional codes in a joint visual representation for a container image.

The binary and/or text information may include additional information concerning the image information. This additional information may include at least one of the following: at least one piece of label and/or calibration data and/or metainformation and/or non-camera data (such as radar data, which are not visual data) and/or multisensor data and/or ultrasound scans and/or fused data (of a multisensor fusion) and/or a temporal orientation or matching of at least two of the pieces of image information, such as a stereo camera recording and/or a time stamp of the sensor-based detection of the image information.

The encoding of the additional data may be designed as visual encoding. This means that the at least one at least one-dimensional code, which may result from the encoding, is designed to be represented as a visual image. The particular at least one-dimensional code may therefore also be designed as a visual code. The visual image may be provided in particular via the container image and/or its at least two-dimensional visual representation.

The container image may be designed as an image file, preferably a “png” file. A png file is an image file that uses the Portable Network Graphics format. It is a file format that is used for compressing image files without impairing the image quality.

The particular at least one-dimensional and preferably two-dimensional code may be designed as a (one- or two-dimensional) barcode or QR code. A barcode is designed in particular in such a way that it is made up of parallel bars having different widths and spacings. The bars represent the at least one piece of binary and/or text information. In contrast, the two-dimensional code or two-dimensional barcode or QR code may be read in the horizontal as well as the vertical direction, and may include a square matrix comprising black and white points.

For the encoding, examples of suitable encoding methods are the Code 128 or Code 39 encoding for barcodes, or the Reed-Solomon or BCH encoding for two-dimensional codes/barcodes/QR codes.

The at least one piece of image information may be specific for the sensor-based detection due to the fact that it results from the sensor-based detection of the surroundings, for example by at least one actual camera or the like, and/or results from augmentation and/or simulation of such a detection. In particular, the detection may determine sensor data that provide the at least one piece of image information. The term “sensor data” refers, for example, to camera images and/or 3D laser scans and/or radar data and/or the like. One advantage of the invention may lie in reducing the complexity of the exchange of sensor data between 2D or multisensor processing tools. In addition, it may be advantageous that the robustness of the relationships between 2D images and additional information is ensured. The risk of incorrect data assignments, in particular for image captions and multisensor data, may be reduced. This often means less development and testing effort. Furthermore, the invention may impede the malicious or unintentional manipulation of sensor data that are present, and their labels.

One concept of the invention lies in having the container image as a single file that contains all information in a machine-readable format. This file may also be read by humans using simple, nonspecialized tools (“tooling”). The combined data may also be stored, examined, and exchanged using standard software that is also available on consumer devices.

Moreover, the embedded and encoded additional data may be machine-readable. It is conceivable to define data encoding and a DNN for which the encoded and possibly multisensor-based additional data may be directly fed into the training and the inference of the DNN.

Furthermore, it is possible for only a single file to have to pass through the processing pipeline, and for there to be a need for no, or only a few, linked secondary files.

Examples of applications for the present invention are the use of the container image having the embedded and encoded additional data, using an image hash (SHA256, for example) and an encoded certificate to ensure authenticity and integrity with respect to changes. In addition, as a result of the invention it may be possible to archive on microfilm the image data provided in the container image without losing the additional information. Furthermore, the invention allows the image information and additional data to be archived in compressed image formats without loss of information (depending on the encoding technology and its robustness). The container images may also be used for training DNNs without knowledge of the prior infrastructure.

In the method according to the invention, it is also conceivable for the following step to be provided:
providing the container image having the embedded encoded additional data for training and/or inference of a machine learning model for classifying digital images.

The at least one piece of binary and/or text information may be provided for use in the training and/or the classification. In addition, the at least one piece of binary and/or text information may provide at least one or multiple labels for the at least one piece of image information. These labels may denote objects and/or actions in the at least one piece of image information. In addition, the image container(s) may be designed as training data for the training. By use of the invention, easier traceability of the training data for the machine learning model, such as a DNN, and in particular for visual and multisensor-based perception, is made possible, and adherence to security standards is thus facilitated.

Moreover, within the scope of the invention it is conceivable for the steps of the method to be carried out repeatedly in order to generate, as the image data, multiple of the container images, in each case with the embedded encoded additional data. The generated image data may be used, at least as part of training data, as input for the machine learning model in order to train the machine learning model, in particular a DNN, for classifying the pieces of image information based on the values of their image points and/or pixels, preferably for object detection for at least semi-automated driving in which the sensor-based detection is carried out for the surroundings of a vehicle.

In addition, within the scope of the invention it is conceivable for the image data to also be generated for the inference as input for the machine learning model, preferably for object detection for at least semi-automated driving.

The majority of the perception in automated driving is based in particular on 2D camera images. Thus, the invention achieves the advantage that a compact data structure is made available for the reliable provision of data for the inference or the training. In this data structure, the image data and preferably 2D images may be used as a container format and enhanced with additional data that are encoded in the image data or 2D images. The location and arrangement of the encoded data in the image data may be arbitrary. These data may be present, for example, in 2D images below, to the left of, to the right of, above, etc., the 2D image information. It is also possible to embed the 2D image information in the code (for example, an embedded image in QR codes).

Furthermore, it may be provided that the following step is provided: providing the container image having the embedded encoded additional data for evaluation of the surroundings detected by sensor.

Further advantages may be that the image information and/or the additional data in the container image are provided with a hash in order to ensure the traceability over all subdata. In this way, a hash of the combined image manipulation recognition of the sensor data and of all encoded data is available. A supplied certificate may guarantee the origin and the scope of the data.

In addition, the binary and/or text information may likewise be specific for the, or a further, sensor-based detection of the surroundings. For example, the at least one piece of binary and/or text information may include at least one of the following pieces of information concerning the at least one piece of image information and/or in addition to the at least one piece of image information:
information such as settings and/or parameter values with which the sensor-based detection has been carried out,
at least one further detection outcome that results from the further sensor-based detection,
a radar image that results from the further sensor-based detection in the form of a radar detection,
a lidar image that results from the further sensor-based detection in the form of a lidar detection,
a further piece of image information of the surroundings that results from the further sensor-based detection, wherein the sensor-based detections for determining the image information and the further image information may be provided using a different image capture technology.

This has the advantage that multiple associated pieces of information may be reliably and securely provided in a container image.

In addition, it is optionally conceivable for the following step to be provided: providing the container image having the embedded encoded additional data for:
a processing algorithm that processes the encoded additional data and the at least one piece of image information in order to evaluate the surroundings detected by sensor, and/or
archiving the container image, and/or
compression using a lossy compression method, and subsequently for a processing algorithm that processes the encoded additional data, embedded in the compressed container image, and the at least one piece of image information in order to evaluate the surroundings detected by sensor.

The processing algorithm may be based on machine learning, but if necessary may also be designed as a rule-based method and/or as an algorithm for pattern recognition. In addition, the processing algorithm may also be a cryptographic algorithm.

It is also advantageous when the additional data or the binary and/or text information contain(s) at least one or multiple information items that denote the at least one or multiple objects that are represented by the at least one piece of image information. In this way, the container image having the embedded encoded additional data may be used for classification and/or pattern recognition, based on the image information and the at least one piece of binary and/or text information. A processing algorithm for classification and/or pattern recognition may utilize the additional data as, for example, a reference, for example as ground truth.

It is also conceivable for the container image to represent the image information by an at least two-dimensional arrangement of image points, preferably pixels. The at least one at least one-dimensional or at least two-dimensional code may be obtained by encoding the additional data. The code may represent the at least one piece of binary and/or text information. Furthermore, the code, likewise via the two-dimensional arrangement, may be embedded in the at least two-dimensional visual representation, spatially outside and/or next to the image information, and preferably may at least partially encompass the image information in this arrangement. This has the advantage that the additional information may be embedded in the container image without impairing the image information represented therein.

The subject matter of the invention further relates to a data structure for enhancing image data with at least one piece of binary and/or text information.

The data structure may have at least one first data element (or multiple data elements), in each case for providing a piece of image information in order to depict the image information in an at least two-dimensional visual representation. The image information may be specific for sensor-based detection of the surroundings.

Furthermore, the data structure may have at least one second data element (or multiple data elements), in each case for providing encoded additional data. The encoded additional data may be used to depict at least one at least one-dimensional code, preferably two-dimensional code, preferably for depicting the additional data together with the at least one piece of image information in the visual representation. The additional data may provide the at least one piece of binary and/or text information.

The at least one piece of binary and/or text information may preferably include at least one additional piece of information concerning the at least one piece of image information and/or the sensor-based detection and/or the surroundings.

The data structure according to the invention thus provides the same advantages as described in detail with regard to a method according to the invention. In addition, the data structure may be suitable for providing a container image by use of a method according to the invention. The data structure may also be present in a nonvolatile form, for example on a data memory.

The visual representation may be designed as an image matrix. The present invention describes in particular how visually encoded additional data may be added to an image by expanding the image matrix. The encoding of the additional data may take place using different conventional encoding technologies, for example generation of a QR code. Other visual encoding technologies may be selected, depending on the data size requirements and the necessary compression and damage resistance. Image format transformations, for example png to jpeg, may also be possible without loss of information.

It is also possible for the data structure according to the invention and/or the method according to the invention to be used for a vehicle. The vehicle may be designed, for example, as a motor vehicle and/or passenger car and/or autonomous vehicle. The vehicle may have a vehicle device, for example for providing an autonomous driving function and/or a driver assistance system. The vehicle device may be designed to at least semi-automatically control the vehicle, in particular to accelerate and/or decelerate and/or steer the vehicle. In particular, the control may take place based on an evaluation of the data structure and/or of the particular container image and the additional data embedded therein, and in particular the at least one piece of image information. The vehicle may also be designed to carry out the sensor-based detection and/or the further sensor-based detection, for example by use of appropriate sensors on the vehicle.

The subject matter of the invention further relates to a computer program, in particular a computer program product, that includes commands which, when the computer program is executed by a computer, prompt the computer to carry out the method according to the invention. The computer program according to the invention thus provides the same advantages as described in detail with regard to a method according to the invention.

The subject matter of the invention further relates to a device for data processing that is configured to carry out the method according to the invention. For example, a computer that executes the computer program according to the invention may be provided as the device. The computer may have at least one processor for executing the computer program. In addition, a nonvolatile data memory may be provided in which the computer program is stored and from which the computer program may be read out by the processor for the execution.

The subject matter of the invention further relates to a computer-readable memory medium that includes the computer program according to the invention and/or commands which, when executed by a computer, prompt the computer to carry out the method according to the invention. The memory medium is designed, for example, as a data memory such as a hard disk and/or a nonvolatile memory and/or a memory card. The memory medium may be integrated into the computer, for example.

In addition, the method according to the invention may also be carried out as a computer-implemented method. Alternatively or additionally, at least one of the disclosed method steps may be computer-implemented and/or carried out in an automated manner.

### BRIEF DESCRIPTION OF THE DRAWINGS

Further advantages, features, and particulars of the invention result from the following description, in which exemplary embodiments of the invention are described in detail with reference to the drawings. The features mentioned in the claims and in the description, in each case alone or in any given combination, may be essential to the invention. In the figures:

FIG. 1 shows a schematic visualization of a method, a device, a memory medium, and a computer program according to exemplary embodiments of the invention.

FIG. 2 shows a schematic illustration of pieces of image information and additional data.

FIG. 3 shows a schematic illustration of an example of a container image.

FIG. 4 shows a schematic illustration of a data structure.

FIG. 5 shows a further schematic illustration of a data structure.

FIG. 6 shows a further schematic illustration of a data structure.

### DETAILED DESCRIPTION

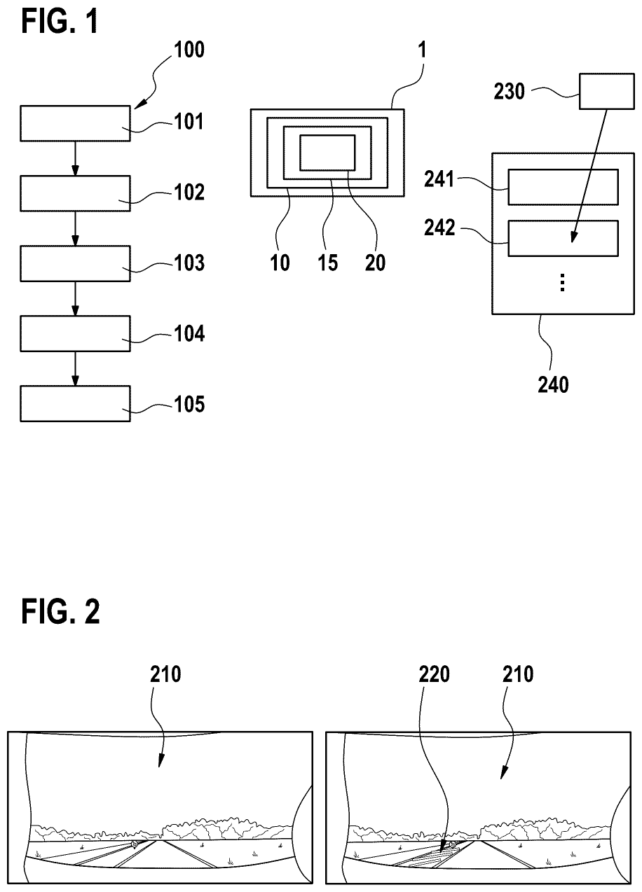

A device 10, a memory medium 15, a data structure 240, and a computer program 20 according to exemplary embodiments of the invention are schematically illustrated in FIG. 1.

FIG. 1 also illustrates, according to exemplary embodiments of the invention, a method 100 for generating image data that are or become enhanced with at least one piece of binary and/or text information 230.

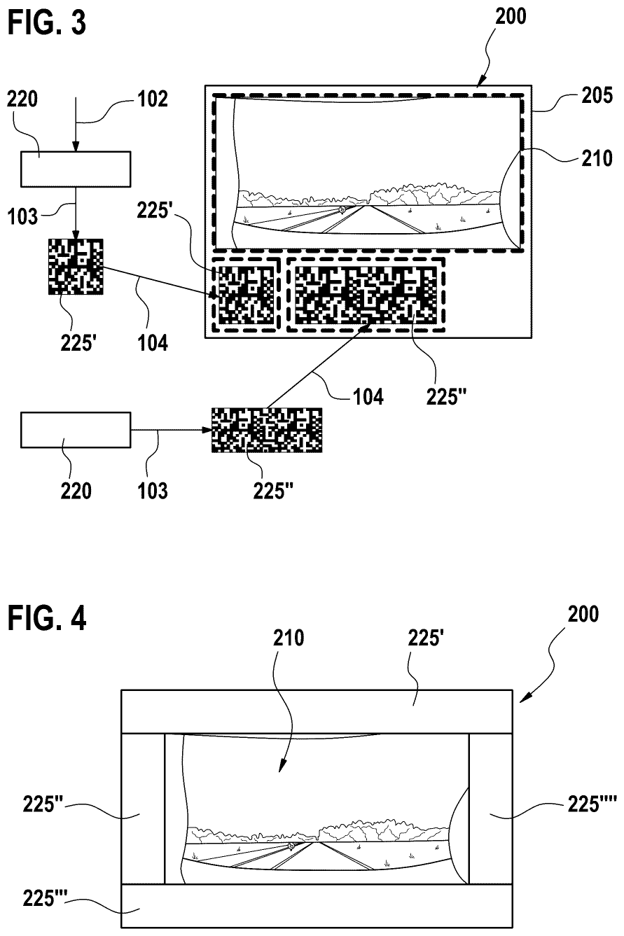

Providing a container image 200 having at least one piece of image information 210 takes place according to a first method step 101 (also see FIGS. 2 and 3). The container image 200 may provide an at least two-dimensional visual representation 205, illustrated by way of example in FIGS. 3 and 4. In addition, the image information 210 may be specific for sensor-based detection of the surroundings, in particular the surroundings of a vehicle 1. At least one piece of image information 210 may advantageously be depicted in the at least two-dimensional visual representation 205. In the examples shown, the image information 210 represents the detected surroundings of the vehicle 1 and depicts, among other things, a roadway ahead.

Providing additional data 220 may take place according to a second method step 102 illustrated in FIG. 1, wherein the additional data 220 provide the at least one piece of binary and/or text information 230. The at least one piece of binary and/or text information 230 may include at least one additional piece of information concerning the at least one piece of image information 210 and/or the sensor-based detection and/or the surroundings (also see FIG. 3 in this regard). For example, the additional data 220 or the binary and/or text information 230 may include at least one or multiple information items which denote at least one or multiple objects that are represented by the at least one piece of image information 210. In the specific example shown, the additional data 220 having the binary and/or text information 230 may provide, for example, a classification, among other things, for the depicted roadway and/or for other road users possibly depicted. In addition, the additional data 220 having the binary and/or text information 230 may optionally provide pieces of information for the detection, such as information items for the sensor system that is used.

Encoding the additional data 220 may be provided according to a third method step 103 in order to represent the additional data 220 by at least one at least one-dimensional code 225. As an example, FIG. 3 illustrates that the particular at least one-dimensional code 225 may be designed as a two-dimensional code 225 such as a data matrix code. At least one further one- or two-dimensional code 225″ may be provided in addition to a first one- or two-dimensional code 225′. FIG. 4 shows yet a third possible at least one-dimensional code 225″ and a fourth at least one-dimensional code 225″.

Embedding the encoded additional data 220 in the container image 200 may take place according to a fourth method step 104 in order to depict the at least one at least one-dimensional code 225, 225′, 225″ together with the at least one piece of image information 210 in the visual representation 205 (see FIG. 3). It is thus preferably possible for the binary and/or text information 230 to also be provided by the container image 200 or by the visual representation 205; however, the binary and/or text information is optionally in encoded form and therefore is no longer directly readable as text information.

Subsequently, according to a fifth method step 105 the container image 200 having the embedded encoded additional data 220 may preferably be provided for training and/or inference of a machine learning model for classifying digital images. It is possible to use the machine learning model to automatedly control a vehicle 1 based on the classification. The images may optionally be detected in real time by a sensor system of the vehicle 1.

FIG. 1 also illustrates a data structure 240 for enhancing image data with at least one piece of binary and/or text information 230. At least one first data element 241 of the data structure 240 may be provided. The one or multiple first data elements 241 may in each case be designed to provide a piece of image information 210 in order to depict the image information 210 in an at least two-dimensional visual representation 205. Correspondingly, the first data element 241 may include an image matrix to accommodate a two-dimensional arrangement of pixel values. In addition, the image information 210 may be specific for sensor-based detection of the surroundings.

Furthermore, at least one second data element 242 of the data structure 240 may be provided. The one or multiple second data elements 242 may in each case be provided to provide encoded additional data 220 in order to depict at least one at least one-dimensional code 225 for representing the additional data 220 together with the at least one piece of image information 210 in the visual representation 205. The additional data 220 may provide the at least one piece of binary and/or text information 230, wherein the at least one piece of binary and/or text information 230 may include at least one additional piece of information concerning the at least one piece of image information 210 and/or the sensor-based detection and/or the surroundings. In addition, the second data element 242 may include an image matrix to accommodate a two-dimensional arrangement of pixel values.

The described data structure 240 allows, for example, the pieces of image information 210 together with the associated additional data 220, such as labels for a joint processing, to be provided.

To train, for example, machine learning models such as deep neural networks (DNNs) for the image processing, pieces of information concerning which objects can be found in the image data of the training data, and possibly also which cannot be found there, may be used. These pieces of information are referred to as “labels.” The labels may be conventionally stored in separate label files. Problems frequently arise with the handling of these label files in various toolchains and organizations. It is therefore advantageous to agree on standards for how label files reference the image data and in particular sensor data. However, this may also have the disadvantages that greater complexity is necessary for storing data transmissions between systems and between organizations, and the risk of incorrect relationships between image data/sensor data and the corresponding label files increases. Therefore, ensuring that security requirements are met often requires a high level of complexity, and each tool that uses the label files must be robust when dealing with multiple files and their relationships.

A similar problem arises with the processing of multisensor data. These data are normally stored in separate files. For example, camera images are stored in .png files, and 3D scans are stored in .pcd files. The processing of these separate files must be correctly implemented in each tool in the data cycle. This becomes even more complicated when the caption files contain captions for multisensor data files and sequences of sensor data.

It is possible that label files may have to be post-processed. One reason may be poor accuracy of the original label file. The traceability of the trained DNN may thus be made more difficult. Since each sensor file may have multiple label files for the same labeled objects, the version of the label file used must also be stored, which increases the complexity and requires a standard that applies to multiple tools for dealing with multiple label file versions. In many cases, an increase in complexity increases the level of effort and the risk of error.

In addition, it is often necessary to archive image data. Specialized data formats which are possibly no longer readable are problematic.

The invention may therefore have the advantage that the additional data are archived as additional relevant information together with the image information, such as for example:
object annotations (also referred to as image labels),
calibration data of the imager or the camera,
time stamps, exposure settings, and other imager information,
geolocalization,
real-time certificates,
additional data from other sensors, for example radar, lidar, ultrasound, inertial measurement unit (IMU), geolocation, and the like.

FIG. 2 illustrates the basic concept of the invention, in which an example of a piece of image information 210 and examples of additional data 220 in the form of labels are depicted.

FIG. 3 shows an example of a container image 200 in the form of a 2D image having encoded additional data 220 as a QR code below the image information 210. Other variants are also possible.

FIG. 4 shows that the encoded additional data 220 may be arbitrarily positioned relative to the image information 210, the latter in the form of a 2D image. Various options are illustrated in this regard. Various combinations may be advantageous, depending on the data volume, encoding standard(s), and other factors.

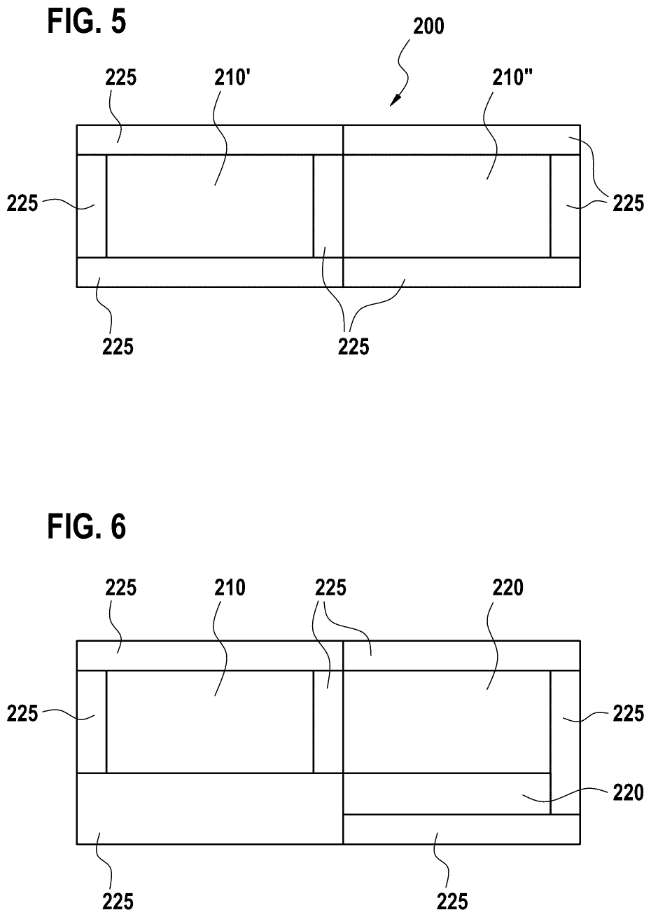

FIG. 5 shows a combination of multiple pieces of image information 210, 210′, 210″ having embedded encoded additional data 220. In other words, multiple images may also be combined. Encoded data that are linked to the combination of the two images may possibly be associated with each image. One application may be the processing of stereo images or surround view images of multiple cameras, radars, lidars, thermal cameras, etc.

FIG. 6 shows a combination of multisensor-based image data made up of pieces of image information 210, additional data 220, and encoded additional data 220 to form a single 2D container image. The container image may be subdivided into arbitrary blocks of visually encoded data (for string or binary data) as well as image representations of various sensors.

In the above explanation of the embodiments, the present invention is described solely in terms of examples. Of course, individual features of the embodiments, if technically feasible, may be freely combined with one another without departing from the scope of the present invention.

1. A method for generating image data that are enhanced with at least one piece of binary and/or text information, comprising the following steps:
providing a container image having at least one piece of image information, wherein the container image provides an at least two-dimensional visual representation in which the at least one piece of image information is depicted, wherein the image information is specific for sensor-based detection of the surroundings,
providing additional data, wherein the additional data provide the at least one piece of binary and/or text information, wherein the at least one piece of binary and/or text information includes at least one additional piece of information concerning the at least one piece of image information and/or the sensor-based detection and/or the surroundings
encoding the additional data in order to represent the additional data by at least one at least one-dimensional code,
embedding the encoded additional data in the container image in order to depict the at least one at least one-dimensional code together with the at least one piece of image information in the visual representation.

2. The method according to claim 1,
characterized in that
the following step is provided:
providing the container image having the embedded encoded additional data for training and/or inference of a machine learning model for classifying digital images,
wherein the at least one piece of binary and/or text information is provided for use in the training and/or the classification, and the at least one piece of binary and/or text information provides at least one or multiple labels for the at least one piece of image information, the labels denoting objects and/or actions in the at least one piece of image information.

3. The method according to claim 2,
characterized in that
the steps of the method are carried out repeatedly in order to generate, as the image data, multiple of the container images, in each case with the embedded encoded additional data, wherein the generated image data are used, at least as part of training data, as input for the machine learning model in order to train the machine learning model for classifying the pieces of image information based on the values of their image points and/or pixels.

4. The method according to claim 3,
characterized in that
the image data are also generated for the inference as input for the machine learning model.

5. The method according to claim 1,
characterized in that
the following step is provided:
providing the container image having the embedded encoded additional data for evaluation of the surroundings detected by sensor,
wherein the binary and/or text information is likewise specific for the, or a further, sensor-based detection of the surroundings, and wherein the at least one piece of binary and/or text information includes at least one of the following pieces of information concerning the at least one piece of image information and/or in addition to the at least one piece of image information:
information such as settings and/or parameter values with which the sensor-based detection has been carried out,
at least one further detection outcome that results from the further sensor-based detection,
a radar image that results from the further sensor-based detection in the form of a radar detection,
a lidar image that results from the further sensor-based detection in the form of a lidar detection,
a further piece of image information of the surroundings that results from the further sensor-based detection, wherein the sensor-based detections for determining the image information and the further image information are provided using a different image capture technology.

6. The method according to claim 1,
characterized in that
the following step is provided: providing the container image having the embedded encoded additional data for:
a processing algorithm that processes the encoded additional data and the at least one piece of image information in order to evaluate the surroundings detected by sensor, and/or
archiving the container image, and/or
compression using a lossy compression method, and subsequently for a processing algorithm that processes the encoded additional data, embedded in the compressed container image, and the at least one piece of image information in order to evaluate the surroundings detected by sensor.

7. The method according to claim 1,
characterized in that
the additional data include at least one or multiple information items that denote the at least one or multiple objects that are represented by the at least one piece of image information in order to use the container image having the embedded encoded additional data for classification and/or pattern recognition, based on the image information and the at least one piece of binary and/or text information.

8. The method according to claim 1,
characterized in that
the container image represents the image information by an at least two-dimensional arrangement of image points wherein the at least one at least one-dimensional or at least two-dimensional code is obtained by encoding the additional data, the code representing the at least one piece of binary and/or text information, and, likewise via the two-dimensional arrangement, being embedded in the at least two-dimensional visual representation, spatially outside and/or next to the image information.

9. A data structure for enhancing image data with at least one piece of binary and/or text information, having
at least one first data element, in each case for providing a piece of image information in order to depict the image information in an at least two-dimensional visual representation,
wherein the image information is specific for sensor-based detection of the surroundings,
at least one second data element, in each case for providing encoded additional data, in order to depict at least one at least one-dimensional code for representing the additional data together with the at least one piece of image information in the visual representation, wherein the additional data provide the at least one piece of binary and/or text information, wherein the at least one piece of binary and/or text information includes at least one additional piece of information concerning the at least one piece of image information and/or the sensor-based detection and/or the surroundings.

10. (canceled)

11. A device for data comprising:
one or more processors; and
non-transitory computer-readable memory medium that includes commands which, when executed by the one or more processors, prompt the one or more processors to:
provide a container image having at least one piece of image information, wherein the container image provides an at least two-dimensional visual representation in which the at least one piece of image information is depicted, wherein the image information is specific for sensor-based detection of the surroundings,
provide additional data, wherein the additional data provide the at least one piece of binary and/or text information, wherein the at least one piece of binary and/or text information includes at least one additional piece of information concerning the at least one piece of image information and/or the sensor-based detection and/or the surroundings
encode the additional data in order to represent the additional data by at least one at least one-dimensional code,
embed the encoded additional data in the container image in order to depict the at least one at least one-dimensional code together with the at least one piece of image information in the visual representation.

12. A non-transitory computer-readable memory medium that includes commands which, when executed by a computer, prompt the computer to:
provide a container image having at least one piece of image information, wherein the container image provides an at least two-dimensional visual representation in which the at least one piece of image information is depicted, wherein the image information is specific for sensor-based detection of the surroundings,
provide additional data, wherein the additional data provide the at least one piece of binary and/or text information, wherein the at least one piece of binary and/or text information includes at least one additional piece of information concerning the at least one piece of image information and/or the sensor-based detection and/or the surroundings
encode the additional data in order to represent the additional data by at least one at least one-dimensional code,
embed the encoded additional data in the container image in order to depict the at least one at least one-dimensional code together with the at least one piece of image information in the visual representation.

13. The method according to claim 3, wherein at least one of:
(a) the machine learning model is a deep neural network (DNN) model; and/or
(b) the machine learning model is trained for object detection for at least semi-automated driving in which the sensor-based detection is carried out for the surroundings of a vehicle.

14. The method according to claim 4, wherein the image data is provided as input for training the machine learning model for at least semi-automated driving.

15. The method according to claim 8, wherein at least one of:
(a) the at least two-dimensional arrangement of image points comprises pixels; and/or
(b) wherein the code at least partially encompasses the image information in the two-dimensional arrangement.
